(19) United States
(12) Patent Application Publication
(10) Pub. No.: US 2016/0038257 A1
(43) Pub. Date: Feb. 11, 2016

(54) COUPLING DEVICE FOR TRANSFERRING A DRIVING MOVEMENT FROM A VIBRATION TRANSFERRING HANDPIECE TO A MEDICAL OR DENTAL TOOL

(71) Applicant: W&H Dentalwerk Bürmoos GmbH, Burmoos (AT)

(72) Inventors: Karlheinz Eder, Lamprechtshausen (AT); Wilhelm Brugger, Wals-Siezenheim (AT)

(73) Assignee: W&H Dentalwerk Bürmoos GmbH, Burmoos (AT)

(21) Appl. No.: 14/821,404

(22) Filed: Aug. 7, 2015

(30) Foreign Application Priority Data
Aug. 8, 2014 (EP) 14180304

(51) Int. Cl. A61C 1/14; A61C 1/00; A61C 1/07

(52) U.S. Cl. CPC A61C 1/148; A61C 1/07; A61C 1/0061

(57) ABSTRACT

A coupling device for transferring a driving motion (and optionally, a working medium) from a vibration transferring handpiece to a medical or dental tool with a first coupling element provided on the handpiece and a second coupling element provided on the tool. One of the first and second coupling elements is designed as a coupling protrusion, and the other coupling element is designed as a coupling recess to receive the coupling protrusion. The coupling protrusion and the coupling recess each have a first section for releasable connection of the two coupling elements, and a second section for positioning the two coupling elements relative to their joint axis of rotation. The second section is formed on the coupling protrusion and on the coupling recess, such that the two coupling elements are guided toward one another and can be displaced along the joint axis of rotation before the two coupling elements are releasably connected to one another by the respective first sections.

### CROSS REFERENCE TO RELATED APPLICATION

The present application claims priority from pending European Patent Application No. 14180304 filed Aug. 8, 2014, which is incorporated herein by reference.

### BACKGROUND

1. Field

The present invention relates to a coupling device for transferring a driving movement and optionally a working medium from a vibration transferring handpiece to a medical or dental tool.

2. Description of Prior Art

Such coupling devices serve to attach a medical tool, which is designed in particular for removal of dental calculus, to a handpiece which has a vibration source. The vibration source is preferably designed as a piezoelectric drive and activates the tool by means of sound or ultrasound.

Such a coupling device for a medical handpiece and tool is known in particular from EP 2 160 997 A1.

This coupling device for releasable connection of a tool to a medical handpiece comprises a first coupling element, which is provided on the tool and a second coupling element, which is arranged on the handpiece. The two coupling elements are connected to one another by means of a ball raceway connection and a contact surface for friction connection to ensure a secure seating. Only through a fixed connection of the tool to the vibration source can there be a transfer of the energy of vibration to the tool. The ball raceway connection therefore has a guide groove running in an essentially helical pattern around the longitudinal axis of the coupling device with a guide element of the other coupling element engaging in the guide groove. The contact surface for friction connection is preferably formed by a conical contact surface on the tool and a complementary contact surface on the handpiece. Due to the twisting of the two coupling elements relative to one another, a friction connection is established between the two contact surfaces.

### SUMMARY

Therefore, an object of the present invention is to create a coupling device for transferring a driving movement from a vibration transferring handpiece to a medical or dental tool, which will make it possible in particular to prevent a faulty connection between the tool and the handpiece, with simplified handling.

According to one exemplary embodiment of a coupling device for transferring a driving movement and optionally a working medium from a vibration transferring handpiece to a medical or dental tool with a first coupling element, which is provided on the handpiece and a second coupling element provided on the tool, wherein one of the two coupling elements is designed as a coupling protrusion, which can be inserted into a coupling recess on the other coupling element, the coupling protrusion and the coupling recess each have a first section for releasable connection of the two coupling elements and a second section for positioning the two coupling elements relative to their joint axis of rotation wherein the second section is formed on the coupling protrusion and on the coupling recess in such a way that the two coupling elements are guided toward one another and can be displaced along the joint axis of rotation before the two coupling elements can be releasably connected to one another by means of the first section.

According to a first exemplary embodiment of the coupling device, the first section for releasable connection of the two coupling elements is formed by a screw connection, preferably a multi-start thread. For positioning the two coupling elements relative to one another, the second section preferably has a cylindrical guide surface on the coupling protrusion and in the coupling recess.

According to a second exemplary embodiment of the coupling device, the first section for releasable connection of the two coupling elements is arranged in front of the second section on the forward end of the lateral surface of the coupling protrusion and on the rear end of the lateral surface of the coupling recess. To be able to more easily introduce the first section of the coupling protrusion into the corresponding section of the coupling recess, the coupling protrusion has a chamfer on its forward end.

According to a third exemplary embodiment of the coupling device, the diameter of the first section on the coupling protrusion and on the coupling recess is smaller than the diameter of the second section on the coupling protrusion and on the coupling recess. In addition, the length of the first section on the coupling protrusion is preferably less than the length of the second section on the coupling recess, so that the two coupling elements are guided toward one another by means of the second section and are displaceable along the joint axis of rotation before the two coupling elements can be combined with one another by means of the first section. In order to relieve the first section on the coupling protrusion during the transfer of the driving movement from the handpiece to the tool, the second section preferably has a groove-type recess on the coupling protrusion.

According to a fourth exemplary embodiment of the coupling device, at least one of the two coupling elements is at least partially made of titanium. In addition, at least one of the two coupling elements is preferably provided at least partially with a wear-resistant coating.

According to any of the preceding exemplary embodiments, the two coupling elements preferably have a fluid channel, so that a working medium can be supplied to the tool. In addition, the two coupling elements preferably have a stop surface, so that the two coupling elements can be braced against one another in the axial direction to the joint axis of rotation.

In addition, according to any of the preceding exemplary embodiments, preferably a supporting region, in particular in the form of a polygon, is provided for applying a tool wrench to one of the two coupling elements.

According to one exemplary embodiment of a method for releasable connection of a medical or dental tool to a vibration transferring handpiece by means of a coupling device according to any one of the preceding exemplary embodiments, it comprises the following steps:
positioning the two coupling elements relative to their joint axis of rotation by inserting the coupling protrusion into the coupling recess until the second section of the coupling protrusion is at least partially arranged in the second section of the coupling recess,
displacing the two coupling elements toward one another and along their joint axis of rotation until the first section of the coupling protrusion engages at least partially in the first section of the coupling recess,
connecting the two coupling elements by means of the first section on the coupling protrusion and on the coupling recess.
   The present coupling device is characterized by one or more of the following advantages.

A faulty connection between the tool and the handpiece is prevented due to the design of one section on each of the two coupling elements of the coupling device, which serves to position the two coupling elements relative to their joint axis of rotation and to mount the two coupling elements displaceably, so that they are guided relative to one another and are displaceable along the joint axis of rotation before the two coupling elements can be releasably connected to one another by means of another section. In particular in the design of the additional section as a screw connection with an inside thread and an outside thread due to the targeted guidance of the two coupling elements relative to one another, improper insertion of the outside thread into the inside thread is prevented.

In addition, the coupling device according to the invention guarantees the user a simple and time-saving method of attaching the tool to the handpiece. It is no longer necessary to repeatedly attach the first coupling element to the second coupling element to properly insert the outside thread on the one coupling element into the inside thread of the second coupling element.

Within the scope of the invention, it is of course self-evident that the coupling device is not limited to vibration transferring handpieces using one vibration source for preparation of surfaces of teeth. Instead such coupling devices may also be used with other driven medical handpieces, such as handpieces that are driven to rotate, for example.

The invention is explained below on the basis of several exemplary embodiments and in conjunction with the accompanying drawings:

### BRIEF DESCRIPTION OF THE DRAWINGS

FIG. 1 shows a medical, in particular dental, treatment device with a vibration transferring handpiece and a medical, in particular dental, tool attached thereto,

FIG. 2 shows a perspective diagram of the coupling device with a first coupling element that is provided on a drive axis of the handpiece and with a second coupling element that is provided on the tool,

FIG. 3 shows a cross section through the drive axis of the handpiece with the coupling element of the coupling device which is designed as a coupling protrusion,

FIG. 4 shows a cross section through the medical tool with the coupling element of the coupling device designed as a coupling recess,

FIG. 5 shows a detailed view of the coupling device, with which the tool and the handpiece, in particular the first coupling element is connected to the second coupling element.

### DETAILED DESCRIPTION

FIG. 1 shows a medical, in particular dental, treatment device 29 with a vibration transmitting handpiece 2 and a medical, in particular dental, tool 3. A vibration source which is preferably designed as a piezoelectric drive is arranged in the handpiece 2. The tool 3 is preferably releasably connected directly to the drive axle of the piezoelectric drive by means of the coupling device, so that the tool 3 can be activated by means of sound or ultrasound. A supply tubing 30 serves to connect the handpiece 2, in particular its drive, to the control unit 31. During operation of the handpiece 2, both the handpiece and the tool 3 are supplied with working media, in particular electricity, as well as spray water for cooling the tool. In addition, the supply tubing 30 serves in particular to transmit electric signals and/or data between the control unit 31 and the handpiece 2. For display and adjustment of the operating parameters for the handpiece 2 as well as for the tool 3, the control unit 31 has at least one display 32 and at least one operating element 33. A container 34 that can be connected to the control unit 31 serves as a fluid source for the spray water for cooling the handpiece 2 and/or the tool.

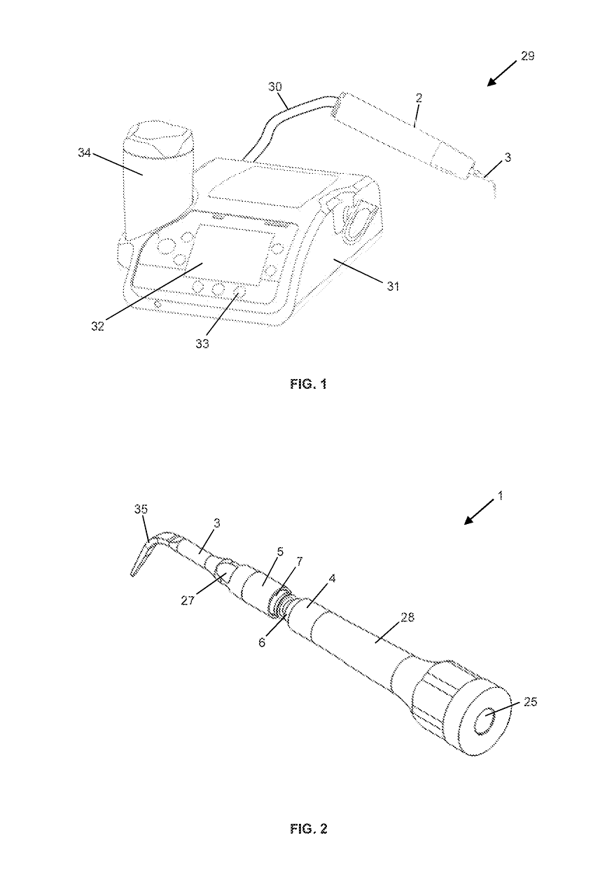

FIG. 2 shows the coupling device 1 according to the invention with a first coupling element 4, which is provided on a drive axle 28 of the handpiece 2, and a second coupling element 5, which is provided on the tool 3. The tool 3 for surface treatment of teeth comprises a tool shaft to which a working head 35 is attached. The working head 35 may have a variety of forms. The coupling element 5 is arranged on the opposite end of the shaft, so that the tool 3 can be releasably fastened onto the other coupling element 4, which is preferably connected to the drive axle 28 of the handpiece 2. The coupling element 4 on the drive axle 28 here is preferably designed as a coupling protrusion 6, which can be inserted into a coupling recess 7 on the other coupling element 5. To fasten the tool 3 securely on the drive axle 28 in this exemplary embodiment, the tool 3 has a supporting region 27, which is preferably designed in the form of a polygon. The tool 3 can thus be securely connected to the axle 28 by means of a tool or wrench. A central borehole 25 through the drive axle 28 and through the coupling device 1 serves as a fluid channel for transfer of spray water, in particular for internal cooling of the tool.

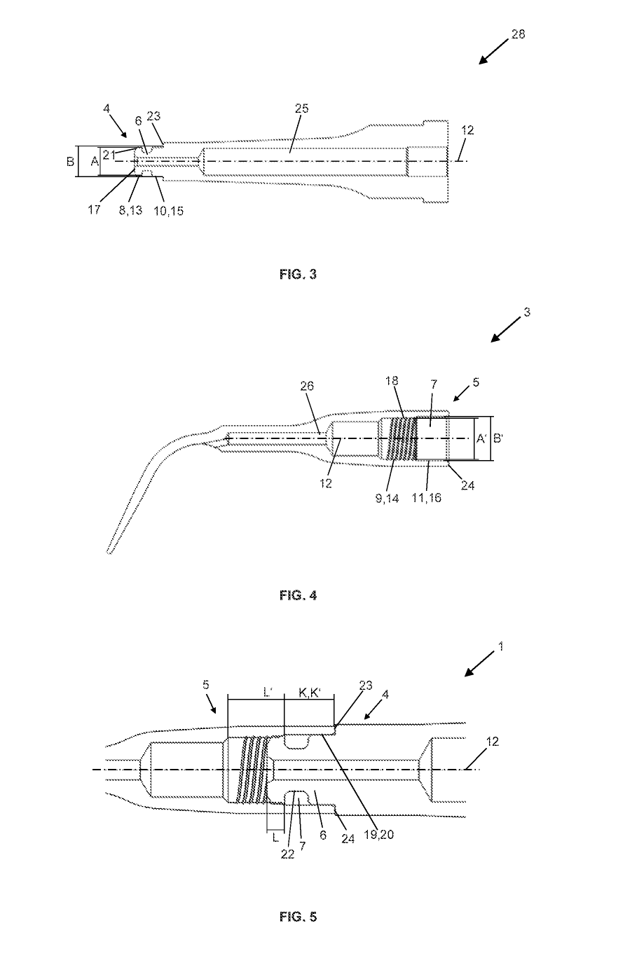

FIG. 3 shows the drive axle 28 of the handpiece 2 with the coupling element 4 of the coupling device 1, where the coupling element is designed as a coupling protrusion 6. The first section 8 on the coupling protrusion 6 for releasable connection of the two coupling elements 4, 5 in this exemplary embodiment is formed by a screw connection 13, which preferably comprises a multi-start thread. The drive axle 28 with the coupling element 4 is preferably manufactured from titanium and has a wear-resistant coating, at least in the area of the screw connection. The second section 10 for positioning the two coupling elements 4, 5 relative to one another is formed by a cylindrical guide surface 15 on the coupling protrusion 6, which extends along the axis of rotation 12. The first section 8 here is arranged on the forward end 17 of the coupling protrusion 6 in front of the second section 10. To facilitate insertion of the first section 8 of the coupling protrusion 6 into the corresponding section 9 of the coupling recess 7, the coupling protrusion 6 has a chamfer 21 on its forward end 17. In order for both coupling elements 4, 5 to be guided by means of the second section 10 and to be displaceable along the joint axis of rotation 12 before the two coupling elements 4, 5 can be connected to one another by means of the first section 8, the diameter A of the first section 8 on the coupling protrusion 6 is designed to be smaller than the diameter B of the second section 10.

The coupling element 4 has a stop surface 23 on the base surface of the drive axle 28, from which the coupling protrusion 6 extends. The stop surface 23 here preferably extends in the radial direction around the coupling protrusion 6. The stop surface 23 is preferably provided with a wear-resistant coating. The corresponding coupling element 5 on the tool 3 also has a stop surface 24, so that the two coupling elements 4, 5 can be braced against one another by means of the first section 8, 9, in particular by means of the screw connection 13, 14 in the axial direction relative to the joint axis of rotation 12.

In this exemplary embodiment, the fluid channel 25 in the drive axle 28 extends along the joint axis of rotation 12 through the coupling element 4, in particular through the coupling protrusion 6 with the first and second sections 8, 10 up to the free end 17 of the coupling protrusion 6.

FIG. 4 shows the medical tool 3 with the coupling element 5 designed as a coupling recess 7 in the coupling device 1. The first section 9 for releasable connection of the two coupling elements 4, 5 is formed by a screw connection 14 having an inside thread, which can be connected to the outside thread 13 on the coupling protrusion 6. The first section 9 here is arranged on the rear end 18 of the coupling recess 7. The second section 11 in the coupling recess 7 for positioning the two coupling elements 4, 5 relative to one another is also formed by a cylindrical guide surface 16, which extends in the axial direction relative to the joint axis of rotation 12. To accommodate the coupling protrusion 6 shown in FIG. 3 in the coupling recess 7, the diameter A′ of the first section 9 is also smaller than the diameter B′ of the second section 11. The two coupling elements 4, 5 are displaceable into one another when guided toward one another by means of the second section 10, 11 before they can be braced against one another by means of the first section 8, 9 and the stop surfaces 23, 24. The fluid channel 26 in the tool 3 can be connected to the fluid channel 25 in the drive axle by means of the coupling device 1.

FIG. 5 shows a detailed view of the coupling device 1, in which the tool 3 and the handpiece 2, in particular the first coupling element 4, are securely connected to the second coupling element 5. This secure and releasable connection is achieved by first positioning the two coupling elements 4, 5 relative to their joint axis of rotation 12 in that the coupling protrusion 6 with the lateral surface 19 is inserted into the coupling recess 7 with the lateral surface 20 until the second section 10 of the coupling protrusion 6 is arranged at least partially in the second section 11 of the coupling recess 7. Then the two coupling elements 4, 5 are guided toward one another and displaced along the joint axis of rotation 12 until the first section 8 of the coupling protrusion 6 engages at least partially in the first section 9 of the coupling recess 7. Finally, the two coupling elements 4, 5 are screwed together by means of the screw connection on the first sections 8, 9 and are braced securely against one another by means of the stop surfaces 23, 24.

A constriction 22 in the lateral surface 19 of the coupling protrusion 6 serves to relieve the first section 8 on the coupling protrusion 6, in particular the screw connection with the inside thread and outside thread in the transfer of the driving motion from the handpiece 2 to the tool 3.

The lengths L, L′ and K, K′ of the first section 8, 9 and the second section 10, 11 on the coupling protrusion 6 and on the coupling recess 7 are selected here, so that the two coupling elements 4, 5 are guided toward one another and can be displaced along the joint axis of rotation 12 before they can be releasably connected to one another by means of the first section 8, 9. In this regard, the length L of the first section 8 on the coupling protrusion 6 in particular is smaller than the length K′ of the second section 11 in the coupling recess 7, so that the second section 10 of the coupling protrusion 6 engages in the coupling recess 7 before the first section 8 of the coupling protrusion 6 can be inserted into the first section 9 of the coupling recess. The length K of the second section 10 on the coupling protrusion 6 as well as the length K′ of the second section 11 on the coupling recess 7 are selected to be as large as possible here, so that accurate positioning and guidance of the two coupling elements 4, 5 relative to one another can take place based on the overlap of the two sections 10, 11.

The present invention is not limited to the exemplary embodiments described here but instead includes all the embodiments that apply or comprise the basic logical function principal of the invention. In addition, all the features of all the exemplary embodiments described and presented here can be combined with one another.

What is claimed is:

1. A coupling device for transferring a driving motion from a vibration transferring handpiece to a medical or dental tool, comprising:
a first coupling element is provided on the handpiece and
a second coupling element provided on the tool,
wherein one of the first and second coupling elements is configured as a coupling protrusion, and the other of the first and second coupling elements is configured as a coupling recess shaped to receive the coupling protrusion,
wherein the coupling protrusion and the coupling recess each have a respective first section for releasable connection of the first and second coupling elements and a respective second section for positioning the first and second coupling elements relative to their joint axis of rotation, wherein the second section is formed on the coupling protrusion and on the coupling recess, such that the first and second coupling elements are guided toward one another and can be displaced along the joint axis of rotation before the first and second coupling elements can be releasably connected to one another by each respective first section.

2. The coupling device according to claim 1, wherein the first section is designed for releasable connection of the first and second coupling elements by a screw connection.

3. The coupling device according to claim 2, wherein the screw connection comprises a multi-start thread.

4. The coupling device according to claim 1, wherein the second section for positioning the two coupling elements relative to one another is formed by a cylindrical guide surface on the coupling protrusion and in the coupling recess.

5. The coupling device according to claim 1, wherein the first section for releasable connection of the first and second coupling elements is arranged in front of the second section on a forward end of a lateral surface of the coupling protrusion and on a rear end of a lateral surface of the coupling recess.

6. The coupling device according to claim 1, wherein the coupling protrusion has on its forward end a chamfer to guide the first section of the coupling protrusion as the coupling protrusion is inserted into the coupling recess.

7. The coupling device according to claim 1, wherein a diameter of the first section on the coupling protrusion and on the coupling recess is smaller than a diameter of the second section, and wherein a length of the first section on the coupling protrusion is smaller than a length of the second section on the coupling recess, so that the first and second coupling elements are guided toward one another by the second section and can be displaced along a joint axis of rotation before the first and second coupling elements can be joined to one another by the first section.

8. The coupling device according to claim 1, wherein the second section has a peripheral constriction on the coupling protrusion to relieve the first section on the coupling protrusion in the transfer of a driving movement.

9. The coupling device according to claim 1, wherein the first and second coupling elements each have a stop surface, so that the two coupling elements can be braced against one another in the axial direction relative to the joint axis of rotation.

10. The coupling device according to claim 1, wherein the first and second coupling elements each have a fluid channel, so that a working medium can be supplied to the tool.

11. The coupling device according claim 1, wherein at least one of the first and second coupling elements has a supporting region shaped to receive a tool.

12. The coupling device according to claim 1, wherein at least one of the first and second coupling elements is made at least in part of titanium.

13. The coupling device according to claim 1, wherein at least one of the first and second coupling elements is provided at least in part with a wear-resistant coating.

14. The coupling device according to claim 1, wherein at least one of the first and second coupling elements can be connected to a vibrating axle of the handpiece.

15. The coupling device according to claim 3, wherein the second section for positioning the two coupling elements relative to one another is formed by a cylindrical guide surface on the coupling protrusion and in the coupling recess.

16. The coupling device according to claim 4, wherein the first section for releasable connection of the first and second coupling elements is arranged in front of the second section on a forward end of a lateral surface of the coupling protrusion and on a rear end of a lateral surface of the coupling recess.

17. The coupling device according to claim 3, wherein the coupling protrusion has on its forward end a chamfer to guide the first section of the coupling protrusion as the coupling protrusion is inserted into the coupling recess.

18. The coupling device according to claim 3, wherein a diameter of the first section on the coupling protrusion and on the coupling recess is smaller than a diameter of the second section, and wherein a length of the first section on the coupling protrusion is smaller than a length of the second section on the coupling recess, so that the first and second coupling elements are guided toward one another by the second section and can be displaced along a joint axis of rotation before the first and second coupling elements can be joined to one another by the first section.

19. The coupling device according to claim 6, wherein a diameter of the first section on the coupling protrusion and on the coupling recess is smaller than a diameter of the second section, and wherein a length of the first section on the coupling protrusion is smaller than a length of the second section on the coupling recess, so that the first and second coupling elements are guided toward one another by the second section and can be displaced along a joint axis of rotation before the first and second coupling elements can be joined to one another by the first section.

20. A method for releasably connecting a medical or dental tool to a vibration transferring handpiece with a coupling device, comprising:
positioning two coupling elements of the coupling device in relation to their joint axis of rotation by inserting a coupling protrusion into a coupling recess until a second section of the coupling protrusion is arranged at least partially inside a second section of the coupling recess,
displacing the two coupling elements relative to one another and along their joint axis of rotation until a first section of the coupling protrusion engages at least partially in a first section of the coupling recess,
connecting the two coupling elements by the first section on the coupling protrusion and on the coupling recess, respectively.
